(19) United States
(12) Patent Application Publication
(10) Pub. No.: US 2013/0316771 A1
(43) Pub. Date: Nov. 28, 2013

(54) Cracker Roller Disc

(71) Applicant: AGCO International GmbH, Neuhausen an Rheinfall (CH)

(72) Inventor: Benjamin Frommelt, Markt Wald OT Immelstetten (DE)

(73) Assignee: AGCO International GmbH, Neuhausen an Rheinfall (CH)

(21) Appl. No.: 13/901,901

(22) Filed: May 24, 2013

(30) Foreign Application Priority Data
May 24, 2012 (GB) 1209117.9

(51) Int. Cl. A01D 82/02

(52) U.S. Cl. CPC A01D 82/02
USPC 460/150; 29/895

(57) ABSTRACT

A method of manufacturing cracker roller discs comprises forming a disc blanks and machining to produce the final form. The disc blank has an axial bore through the centre, a first portion radially outward of the centre of substantially constant thickness, a second portion radially outward of the first portion which second portion tapers towards the periphery of the disc blank, and a plurality of upstanding ridges extending radially outward across the second portion on opposed faces of the disc. Machining, suitably by turning on a lathe, removes the top part of each ridge and leaves at least one sharp edge extending along it, with all ridges on a face being machined in a single operation.

### BACKGROUND OF THE INVENTION

1. Field of Invention

This invention relates to a cracker roller assembly on a forage harvester or similar agricultural harvesting machine and, more specifically, to discs for use in such an assembly, to a method for the manufacture of such discs, and to discs produced by the method.

2. Description of Related Art

Forage harvesters are used to harvest different kinds of crops which may require different harvesting processes. If, for example, grass is harvested the forage harvester cuts the grass from the field, compresses the grass in the compression rollers before chopping the harvested material into smaller parts in a chopper drum. The chopped grass is then discharged by a blower via a spout into an accompanying trailer. If, for example, a kernel crop such as maize, is harvested the harvesting process requires an additional step to crack the closed skin of the kernels, therefore, a cracker unit is provided between the chopper drum and the blower to crush each kernel.

Cracker units typically comprise two longitudinal cracker rollers which are arranged with a roller gap (longitudinal space) between them through which harvested crop is fed. As shown in International Patent Application WO 2012/010396 (commonly assigned with the present application) the cracker rollers may be formed by an arrangement of multiple cracker roller discs mounted on a common shaft. Another example is the disc cracker offered by Maschinenfabrik Bernard Krone GmbH (illustrated at http://landmaschinen.krone.de/index.php?id=2548&L=1). Such a multi-disc arrangement has a number of advantages compared to a unitary roller in terms of manufacturing and maintenance costs. For example, foreign object damage occasioned by a solid object passing through the roller gap may be remedied by the replacement of just a few of the discs rather than a complete, and much more expensive, roller.

Each disc typically has an arrangement of radial cutting surfaces across each face to assist in breaking up the material. With a large number (between 20 and 40) of discs in a typical cracker roller assembly, an efficient method of manufacture is clearly desirable. One current technique involves casting the individual discs followed by individual dressing of the cutting surfaces. An alternative technique comprises lathe turning of a blank of material to generate a disc shape and then milling the surface of the blank to cut in the individual cutting edges. Such techniques are relatively slow as the individual cutting surfaces are addressed one at a time in a lengthy sequence of operations which increases with the number of cutting surfaces on the disc.

### BREIF SUMMARY OF THE INVENTION

An object of the present invention is to provide an efficient method for the manufacture of cracker roller discs.

According to a first aspect of the present invention there is provided a cracker roller disc, comprising the a disc blank having an axial bore through the centre, a first portion radially outward of the centre of substantially constant thickness, a second portion radially outward of the first portion which second portion tapers towards the periphery of the disc blank, the disc blank further having a plurality of upstanding ridges extending radially outward across the second portion on opposed faces of the disc, wherein:

the ridges are provided with machined surfaces extending radially across the second portion and forming an edge 62 along the complete contour of the ridges; and a part of the lands between adjacent ridges and radially inward from the periphery is not machined.

Also in accordance with the invention there is provided a method of manufacturing cracker roller discs, comprising:

in a first stage (40) forming a disc blank having an axial bore through the centre, a first portion radially outward of the centre of substantially constant thickness, a second portion radially outward of the first portion whereby the second portion tapers towards the periphery of the disc blank, the disc blank further having a plurality of upstanding ridges extending radially outward across the second portion on opposed faces of the disc; and

in a second stage (41) machining each of the opposed faces of the disc blank to remove the top part of each ridge and leave at least one sharp edge (64, 66) extending along each ridge, with all ridges on a face being machined in a single operation.

Preferred features of the invention are set out in the dependent claims attached hereto and will be described below with reference to exemplary embodiments of the invention.

By machining all of the ridges on a face of the disc blank in a single operation, suitably by turning the disc on a lathe, all of the cutting surfaces are formed together. The method is efficient as it does not require individual finishing of cutting surfaces, and it does not take longer if a greater number of cutting surfaces per disc are required.

BREIF DESCRIPTION OF THE DRAWINGS

The invention will now be described, by way of example only, with reference to the following drawings in which:

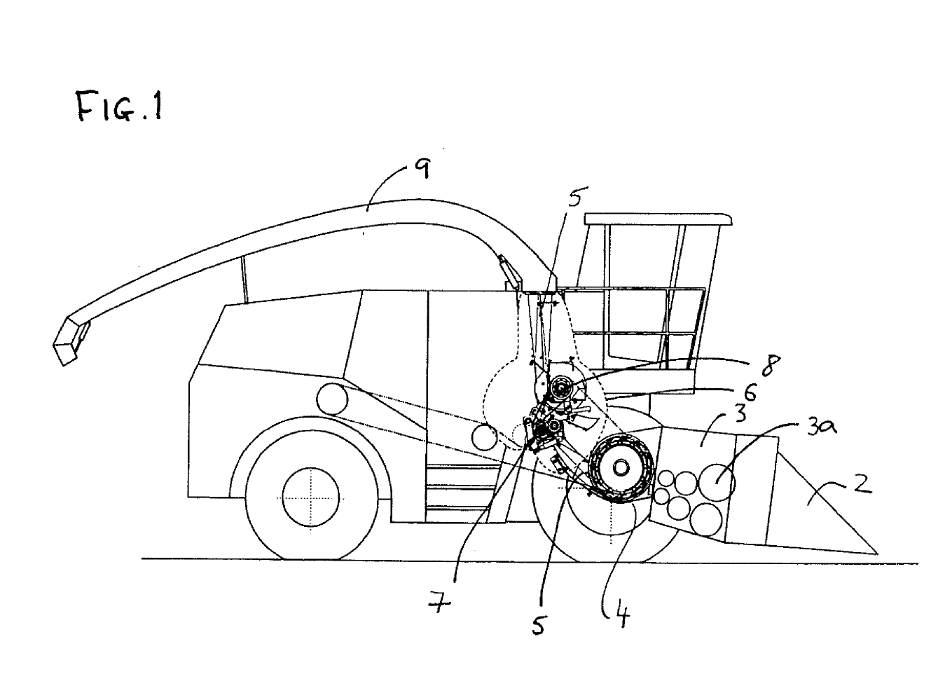

FIG. 1 is a schematic view showing functional components of a forage harvester;

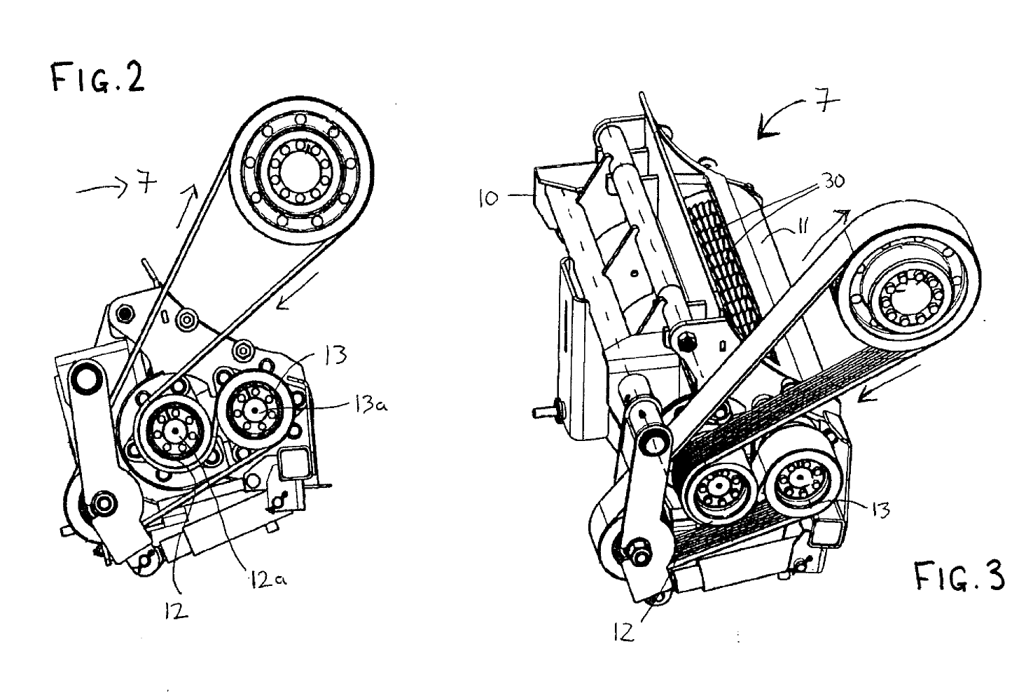

FIGS. 2 and 3 show respectively end view and perspective view of the cracker unit of FIG. 1;

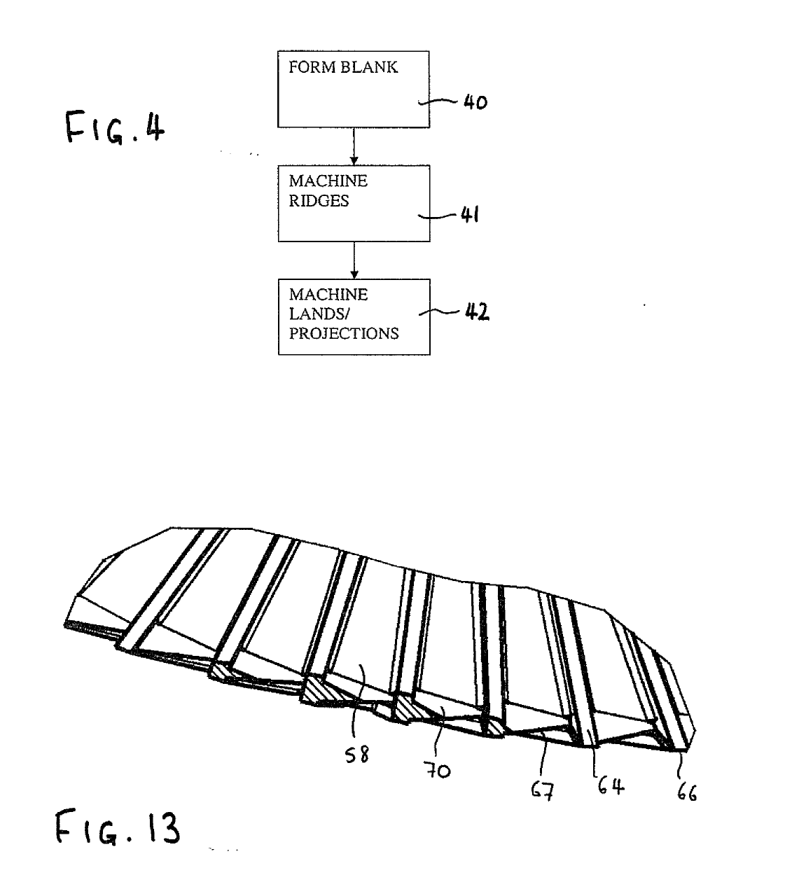

FIG. 4 is a flow chart representation of a method according to the invention;

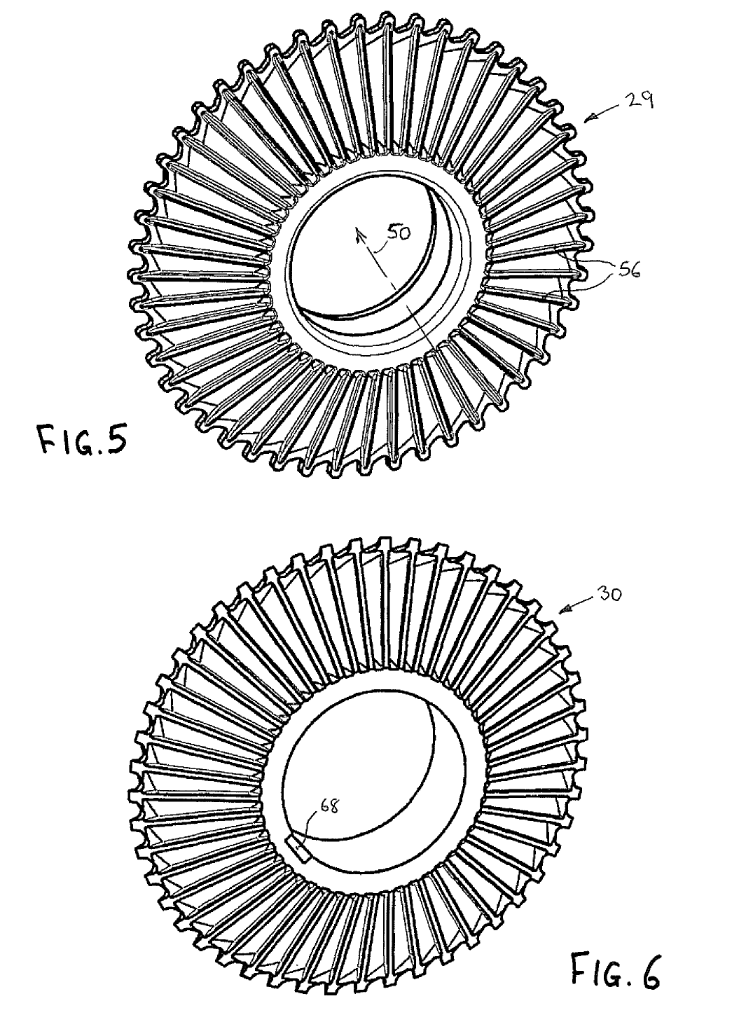

FIG. 5 is a perspective view of a forged disc blank;

FIG. 6 is a perspective view of a machined disc;

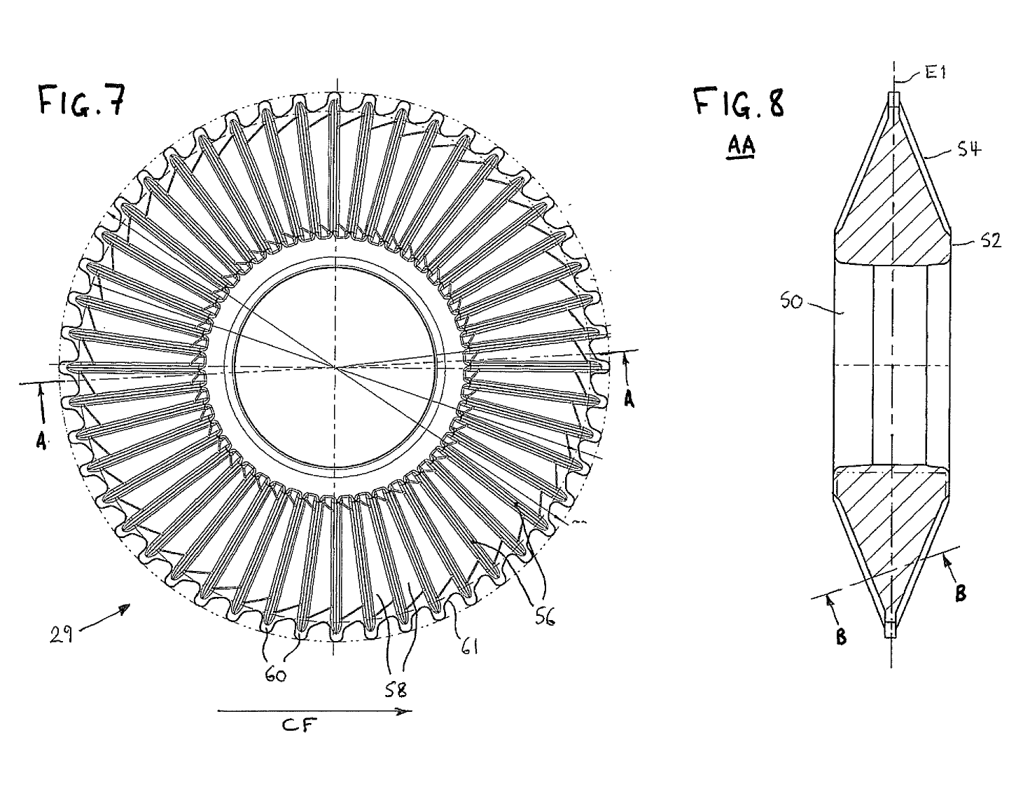

FIGS. 7 and 8 show respectively plan and sectional views of a forged disc blank;

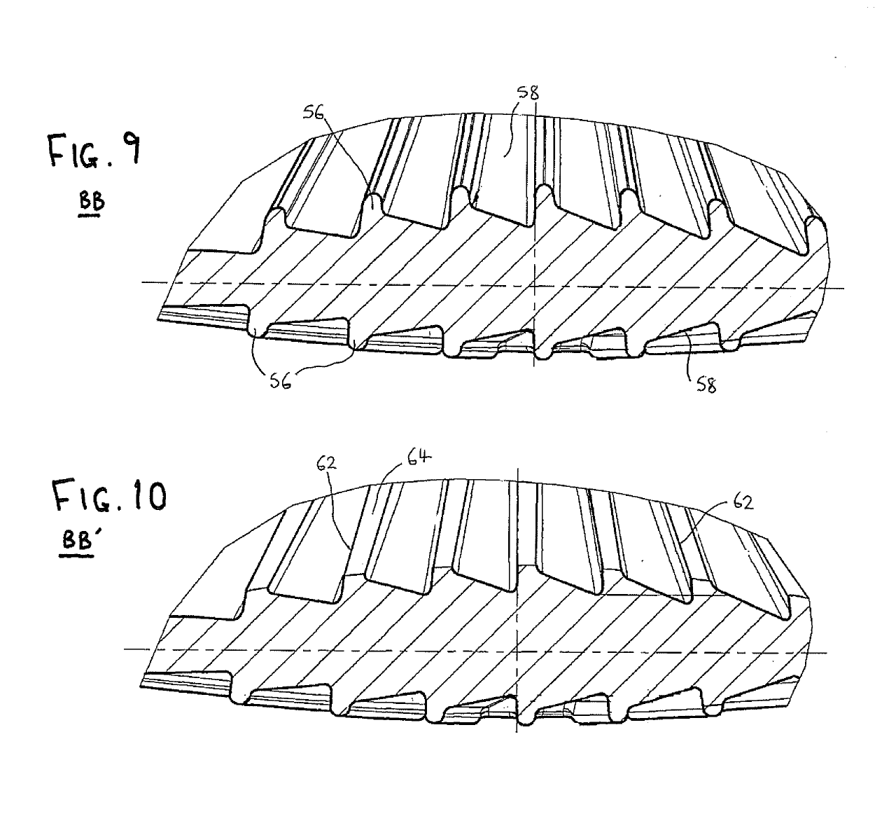

FIGS. 9 and 10 show sectional views through the disc blank at different stages in the manufacturing process;

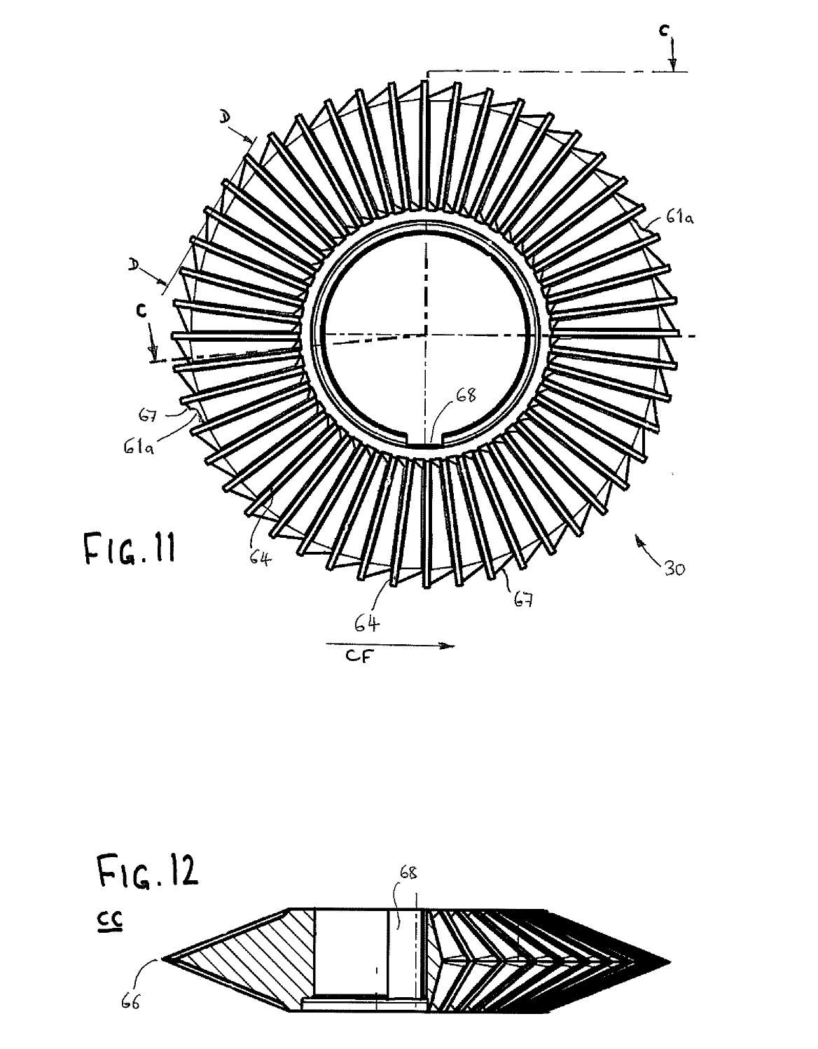

FIGS. 11, and 12 show respectively plan and half-sectional views of a finished cracker roller disc; and

FIG. 13 is a sectional view through a part of the disc of FIG. 11.

### DETAILED DESCRIPTION OF THE INVENTION

FIG. 1 shows a forage harvester 1 provided with a front attachment 2 which contains cutting equipment for cutting a crop. The cut crop is fed through a series of compression rolls 3a in a compression roller housing 3 to a chopper drum 4 where the crop is chopped into smaller pieces. The chopped crop passes through duct 5 and is fed through the cracker unit 6 where the crop is further crushed and threshed. The harvested crop is then blown upwards along duct 5 by accelerator 8 and exits through spout 9. In FIG. 1 the cracker unit 6 is shown in an operational position: in a non operational position, the cracker unit 6 is pivoted to the side of the duct 5 and therefore harvested crop by-passes the cracker roller assembly 7 as it moves through duct 5.

FIGS. 2 and 3 show a cracker roller assembly 7. The cracker roller assembly 7 comprises two frame parts 10 and 11 (not shown in FIG. 2). Two cracker rollers 12 and 13, each formed from seventeen discs 30 mounted on respective roller shafts 12a, 13a, are mounted to a respective frame part 10, 11. The cracker roller discs 30 are provided with teeth for cracking/crushing the harvested crop which can be seen more clearly in FIGS. 6 and 11. The cracker rollers 12, 13 are mounted parallel to each other and are rotatable about their longitudinal axes. A longitudinal space between the rollers, the roller gap, allows the cut crop to pass between the rollers.

As will be understood, the dimensions of each of the discs 30, and the number of discs per roller, may be varied. One factor affecting potential variation is the characteristics of the material to be harvested.

The method of manufacture of the cracker roller discs 30 may be considered as a three-stage process, as represented by FIG. 4. The first stage 40 comprises forming a disc blank, the second stage 41 comprises machining of ridges on the surfaces of that blank, and the third stage 42 comprises machining of peripheral features to create further cutting edges. Each of these steps is described in more detail below.

FIGS. 5 and 6 respectively show perspective views of the disc blank 29 and machined disc 30. FIG. 7 shows the disc blank 29 in plan view, and FIG. 8 is a sectional view through the disc blank taken on line AA of FIG. 7. The blank has an axial bore 50 through the centre, a first portion 52 radially outward of the centre of substantially constant thickness, and a second portion 54 radially outward of the first portion which second portion tapers towards the periphery of the disc blank. A suitable taper angle is 21.8 degrees, although variation is possible as mentioned above.

The disc blank 29 is a steel body formed by forging. C45 steel is a suitable material, although other forgeable steels may be used instead. As part of the blank forming step, the forging process creates a plurality of upstanding ridges 56 extending radially outward across the second portion 54 on each face of the disc.

FIGS. 9 and 10 are sectional views through the disc blank taken on line BB in FIG. 8. From FIG. 9 it can be seen that the radial ridges 56 have a generally rounded profile in their upper (furthest from the disc body) portion. The lands 58, defined as the portions of disc surface between the ridges 56, are sloped from one ridge to the next to give a generally sawtooth profile. The disc blank 29 shown has 48 ridges of substantially constant width. It will be recognised that greater or fewer ridges may be provided, with the ridge height and separation being determined by the need to accommodate grain and other material of the particular crop being handled.

As can be seen from FIG. 9, the step of forming (first stage 40) includes circumferentially aligning each ridge 56 on a first face of the disc blank 29 with a corresponding ridge on the opposing face of the disc blank. Furthermore, the step of forming includes aligning the distal ends of each corresponding pair of ridges 56 with radial projections 60 spaced around the periphery of the disc blank 29, as can be seen particularly in FIG. 7. Adjacent radial projections 60 are connected via a contour 61 which is inclined radially inwards in the direction of crop flow (indicated by arrow CF) to give a generally sawtooth profile in the direction of crop flow.

Reverting to FIG. 4, the second stage 41 of the process comprises machining each of the opposed faces of the disc blank to remove the top part of each ridge 56 and leave at least one sharp edge 62 providing a cutting edge extending along each ridge, with all ridges on a face being machined in a single operation. Additionally, this stage removes parts of the radial projections 60. The surface of the second portion 52 and the inner surface of the bore 50 may also be machined in this operation. The section view of FIG. 10 shows one (upper) face of the disc having been machined to produce machined surfaces 64 and the edges 62, whilst the other (lower) face is not machined and the ridges still have the rounded profile created during the forging process. Preferably the second stage 41 is done by turning on a lathe, but may also be provided by milling in a radial direction.

FIG. 11 is a plan view of the machined disc 30, FIG. 12 is a half section through the disc of FIG. 11 taken on line CC, and FIG. 13 is a part section through the disc of FIG. 11 taken on line DD. Comparing particularly FIGS. 7, 11 and 13, it can be seen that the third stage 42 step of machining includes removing a portion of each radial projection 60 from either side of the disc blank and creating a machined area 70 of the lands 58. The machined area 70 is provided by a milling step whereby the milling cut is made at an angle inclined to the symmetry plane El shown in FIG. 8 so that the machined surfaces 70 of the opposing faces theoretically meet in a sharp radial inclined edge 67. Due to tolerances, this radial inclined edge 67 may be interrupted, so that contour 61 is partly present as shown in FIG. 11 with line 61a. This is not deleterious to the functioning of the disc.

In the illustrated embodiment, the design of ridges 56 is such that the machined surfaces 70 are of constant width so that, in order to create them, a milling tool with one diameter need only be moved once in between the ridges 56.

As can be seen in FIGS. 11 to 13, the machined surfaces 64 of each ridge meet in a sharp radial edge 66. Both edges 66 and 67 assist in the cutting of crop kernels together with leaves and stalk parts that have not been cleanly cut by the chopping drum 4 (FIG. 1).

This is preferably accomplished by turning the disc blank 29 in a second stage 41 of the process on a lathe using a single cutting tool to remove the upper part of all ridges 56 and peripheral portions 60 on a first side of the disc blank in a single turning operation, before reversing the disc blank on the lathe and machining the second side. Alternatively, a milling tool could be used to be moved along the ridges 56.

The third stage 42 of the process is preferably accomplished on a milling machine. As will be recognised, it is a further particular benefit that all of the cutting edges 67 are provided by milling the machined surface 70 which extends only partly into the lands 58, so that time on the machining tool can be greatly reduced compared to prior art techniques. In the embodiment shown, third stage 42 requires one-eighth of the conventional machining time as the movement of the machining tool is only 10 mm instead of 80 mm when machining the complete land 58. Furthermore, machining the complete land 58 would require a more complex pattern of movement of the tool as the machined surface would be more of a triangular shape, preventing the machining with a larger tool in the radially inward parts of the land 58.

If the second stage 41 and third stage 42 of the process are accomplished by using a milling machine in one step (one clamping required for each side), there is still a time saving due to the partial machining of land 58 to create machined surface 70.

Furthermore, if using a lathe to carry out the second stage 41 it may be possible to effect the third stage 42 on the same machinery if the lathe is equipped with driven tools and positionable (milling) spindle.

As used herein in relation to the invention, the term “machining” means every kind of operation in which a cutting tool or the part itself is pivoted to cut contours from said part.

The process of milling may include known milling techniques, e.g.
End/Face milling: characterised in that the tool penetrates the part along its rotational axis whereby the end face can be completely used to cut the part. In the case of stage 41, the machined surface 64 is approximately perpendicular to the rotational axis of the milling tool.
Cylindrical or plain/peripheral milling: characterised in that the tool penetrates the part perpendicular to its rotational axis whereby the circumferential face can be completely used to cut the part. In the case of stage 41, the machined surface 64 is approximately parallel to the rotational axis of the milling tool.

Furthermore, grinding (end grinding or plain grinding) could also be used according to the procedures described for milling above, although this is not a preferred option due to the typically much higher costs involved.

Referring to the first stage 40, the above embodiment describes the disc blank as a forged part. However, it will be understood that any procedure to provide a disk blank, e.g. steel casting and hardening afterwards, may be used instead. In such a case, the second stage 41 and/or third stage 42 may require the usage of grinding. Even with such a method, the partial machining of lands 58 still results in a time saving.

Referring back to FIG. 3, the present invention also provides a cracker roller 12, 13 made up of discs 30 manufactured as described above and mounted on a roller shaft 12a, 13a. To assist this, an axially extending keyway 68 is cut in the wall of the bore 50 through the disc blank: when mounted on a roller shaft 12a, 13a, a radially extending key or projection (not shown) from the shaft engages the keyway 68 to prevent the discs 30 rotating relative to the shaft.

From reading of the present disclosure, other modifications will be apparent to those skilled in the art and the scope of the invention is limited only by the following claims.

1. A cracker roller disc, comprising a disc blank having an axial bore through the centre, a first portion radially outward of the centre of substantially constant thickness, a second portion radially outward of the first portion which second portion tapers towards the periphery of the disc blank, the disc blank further having a plurality of upstanding ridges extending radially outward across the second portion on opposed faces of the disc, wherein:
the ridges are provided with machined surfaces extending radially across the second portion and forming an edge along the complete contour of the ridges; and
a part of the lands between adjacent ridges and radially inward from the periphery is not machined.

2. A disc as claimed in claim 1, further having an outer machined area of each of the lands with a sharp edge extending between adjacent ridges.

3. A method of manufacturing a cracker roller disc, comprising:
in a first stage forming a disc blank having an axial bore through the centre, a first portion radially outward of the centre of substantially constant thickness, a second portion radially outward of the first portion whereby the second portion tapers towards the periphery of the disc blank, the disc blank further having a plurality of upstanding ridges extending radially outward across the second portion on opposed faces of the disc; and
in a second stage machining each of the opposed faces of the disc blank to remove the top part of each ridge and leave at least one sharp edge extending along each ridge, with all ridges on a face being machined in a single operation.

4. A method as claimed in claim 3, further comprising in a third stage machining in a single operation each of the opposed faces of the disc blank to remove an outer part of each land between adjacent pairs of ridges and leave at least one sharp edge between adjacent ridges.

5. A method as claimed in claim 3, wherein the first stage includes circumferentially aligning each ridge on a first face of the disc blank with a corresponding ridge on the opposing face of the disc blank.

6. A method as claimed in claim 5, wherein the first stage further comprises aligning the distal ends of each corresponding pair of ridges with radial projections spaced around the periphery of the disc blank.

7. A method as claimed in claim 6, wherein the second stage includes removing a portion of each radial projection from either side of the disc blank.

8. A method as claimed in claim 7, wherein the machined surfaces of each radial projection meet in a sharp radial edge.

9. A method as claimed in claim 3, wherein the disc blank is steel and the first stage comprises forging the disc blank.

10. A method as claimed in claim 3, wherein the second stage comprises turning the disc blank on a lathe using a single cutting tool to remove the upper part of all ridges on a first side of the disc blank in a single turning operation.

11. A method as claimed in claim 3, wherein the second stage comprises milling the disc blank on a milling machine using a single cutting tool to remove the upper part of all ridges on a first side of the disc blank in a single milling operation.

12. A method as claimed in claim 3, wherein the third stage comprises milling the disc blank on a milling machine using a single cutting tool to remove the outer part of lands on a first side of the disc blank in a single milling operation.

13. A method as claimed in claim 12, wherein the outer part of each land is removed to leave a surface inclined to the symmetric plane.

14. A method as claimed in claim 12, wherein each outer part of each land is removed in a single radial movement of a tool with constant diameter.

15. A method as claimed in claim 3, further comprising cutting an axially extending keyway in the wall of the bore through the disc blank.

16. A cracker roller disc produced by a method according to claim 3.

17. A cracker roller comprising a plurality of discs as claimed in claim 1, axially aligned and mounted on a common shaft.
